(19) United States
(12) Patent Application Publication
(10) Pub. No.: US 2024/0082995 A1
(43) Pub. Date: Mar. 14, 2024

(54) HAND TOOL WITH LOCKING FLEXIBLE HEAD

(71) Applicants: MINGLIN SHI, Shanghai (CN); Apex Brands, Inc., Apex, NC (US)

(72) Inventors: Minglin Shi, Shanghai (CN); Cheng Yang, Shanghai (CN); Yi-Hsiang Tseng, Taiwan (CN); Tsung-Hsien Shen, Taiwan (CN)

(21) Appl. No.: 18/272,416

(22) PCT Filed: Jan. 28, 2021
(86) PCT No.: PCT/CN2021/074128

§ 371 Date: Jul. 14, 2023

(51) Int. Cl. B25B 23/00

(52) U.S. Cl. CPC B25B 23/0028

(57) ABSTRACT

A hand tool (100,200) may include a head portion (110,210) configured to interface with a fastener, a shaft (120,220) and a grip portion at which an operator is enabled to hold the hand tool during operation, and a flexible interface (130,230) configured to operably couple the shaft and the head portion in a locked state and an unlocked state. The flexible interface is also configured to enable the head portion to pivot relative to the shaft about a pivot axis that extends substantially perpendicular to a direction of extension of the shaft. In the unlocked state, an angle of the head portion may be pivotable relative to the pivot axis. In the locked state, the angle of the head portion may be fixed. The flexible interface may include a locking assembly (150) including an actuator (152, 250, 250′) having a locked position defining the locked state and an unlocked position defining the unlocked state. The flexible interface may also include a retention assembly (160) configured to retain the actuator in each respective one of the locked position and the unlocked position.

### TECHNICAL FIELD

Example embodiments generally relate to hand tools and, in particular, relate to a ratchet, wrench or other hand tool having a flexible head that can be locked in either an adjusted position, or in an adjustable position.

### BACKGROUND

Hand tools are commonly used across all aspects of industry and in the homes and workshops of consumers. Hand tools are employed for multiple applications including, for example, fastener tightening, component joining, and/or the like. For some fastener tightening applications, such as those involved in tightening of hex headed nuts or bolts, an open-end, box-end or combination wrench may be employed. Open-end wrenches typically have a head portion that has a U-shaped opening to grip opposing sides of the nut or bolt disposed at one or both ends of a shaft (or handle). Box-end wrenches instead have a head portion that has an enclosed opening to grip faces of the nut or bolt at one or both ends of the shaft. Meanwhile, combination wrenches have an open-end wrench head at one end and a box-end wrench head at the other end of the shaft.

Other types of wrenches are also possible, including wrenches that have a head portion configured with jaws that are adjustable relative to each other (e.g., to fit different sizes of fastener), or wrenches that have a head portion with a square drive configured to engage a socket. For some cases, in order to provide the ability to accurately apply torque, a class of hand tools referred to generally as torque wrenches have been developed. Torque wrenches are calibrated devices that enable the operator to know when a particular torque is reached. The means by which the operator is informed of the fact that the particular torque has been reached can vary with corresponding different types of torque wrenches.

For some of the different types of wrenches described above, ratcheting assemblies may be provided to enable the operator to continue to turn a fastener without removing and reorienting the wrench relative to the fastener. Such ratcheting assemblies are often placed in the head portion of box-end wrenches or wrenches configured to drive sockets. When a wrench employs a ratcheting assembly, the wrench may be referred to as a ratchet wrench or simply as a ratchet.

The head portions of many of the wrenches described above may be flared (e.g., angled relative to the longitudinal centerline of the shaft). However, having a fixed angle may be limiting in some case, thus some wrenches may be designed to be flexible (e.g., having a flexible head portion) to enable different angles to be achieved for the head portion relative to the longitudinal centerline of the shaft. Particularly for wrenches or ratchets that have a flexible head portion, the cost and complexity of designing the flexible head portion can be prohibitive. Thus, it may be desirable to provide improved designs that can be easy for operators to use, but also provide low cost and complexity for production and maintenance.

### BRIEF SUMMARY OF SOME EXAMPLES

Some example embodiments may enable the provision of an improved flexible interface between the head portion and the shaft of a hand tool (e.g., a wrench or ratchet).

In an example embodiment, a hand tool may be provided. The hand tool may include a head portion configured to interface with a fastener, a shaft having a a grip portion at which an operator is enabled to hold the hand tool during operation, and a flexible interface configured to operably couple the shaft and the head portion in a locked state and an unlocked state. The flexible interface is also configured to enable the head portion to pivot relative to the shaft about a pivot axis that extends substantially perpendicular to a direction of extension of the shaft. In the unlocked state, an angle of the head portion may be pivotable relative to the pivot axis. In the locked state, the angle of the head portion may be fixed. The flexible interface may include a locking assembly including an actuator having a locked position defining the locked state and an unlocked position defining the unlocked state. The flexible interface may also include a retention assembly configured to retain the actuator in each respective one of the locked position and the unlocked position.

In another example embodiment, a flexible interface for a hand tool may be provided. The flexible interface may operably couple a head portion and a shaft of the hand tool and enable the head portion to pivot relative to the shaft about a pivot axis that extends substantially perpendicular to a direction of extension of the shaft. The flexible interface may include a locking assembly and a retention assembly. The locking assembly may include an actuator having a locked position defining a locked state for the hand tool and an unlocked position defining an unlocked state for the hand tool. In the unlocked state, an angle of the head portion may be pivotable relative to the pivot axis. In the locked state, the angle of the head portion is fixed. The retention assembly may be configured to retain the actuator in each respective one of the locked position and the unlocked position.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a block diagram of a hand tool in accordance with an example embodiment;

FIG. 2A illustrates a perspective view of a wrench as one example of the hand tool of FIG. 1 according to an example embodiment;

FIG. 2B illustrates a different perspective view of the wrench of FIG. 2A according to an example embodiment;

FIG. 3 illustrates an exploded view of some parts of the wrench according to an example embodiment;

FIG. 4 illustrates some portions of a flexible interface according to an example embodiment;

FIG. 5 illustrates a cross section view of the flexible interface according to an example embodiment;

FIG. 6A illustrates a perspective view of portions of a locking assembly and a retention assembly associated with an actuator of the flexible interface in the locked state according to an example embodiment;

FIG. 6B illustrates another perspective view of the locking assembly and retention assembly in the locked state according to an example embodiment;

FIG. 6C is a side view of the actuator according to an example embodiment;

FIG. 6D illustrates the locking assembly and retention assembly in the unlocked state according to an example embodiment; and

FIG. 7 a cross section view of an alternative structure for a flexible interface according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

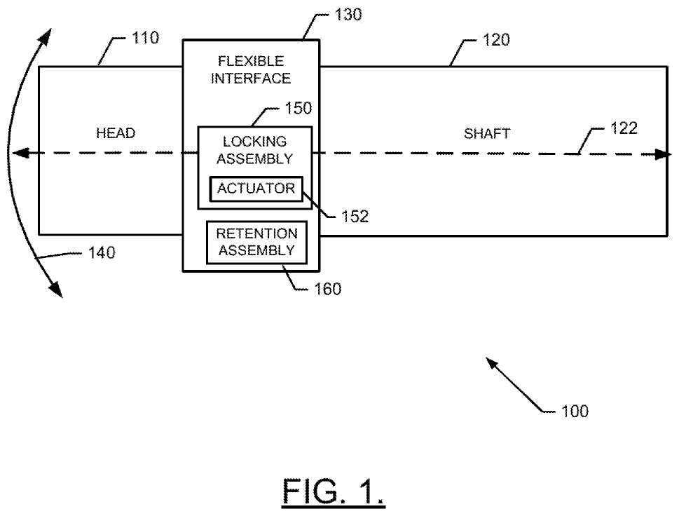

As indicated above, some example embodiments may relate to improvements to the design of a hand tool with a flexible head portion. FIGS. 1-6 show various views or portions of one such example embodiment. In this regard, FIG. 1 illustrates a block diagram of a hand tool 100 with a flexible head 110 (or head portion). The head 110 is operably coupled to a shaft 120 that has a longitudinal centerline 122 via a flexible interface 130. The flexible interface 130 is structured to allow the head 110 to be pivoted about an axis that extends substantially perpendicular to the longitudinal centerline 122 either upward or downward as shown by double arrow 140. The head 110 may be aligned with the longitudinal centerline 122 (i.e., not pivoted), or may be pivoted out of alignment with the longitudinal centerline 122 either upwardly or downwardly to enable the operator to define an amount of angular difference that may be provided between the longitudinal centerline 122 and the head 110, and therefore define the angular difference between the head 110 and the shaft 120. When the head 110 is pivoted out of alignment with the shaft 120, the hand tool 100 may fit in smaller areas or provide a more convenient or comfortable grip for the operator.

In an example embodiment, the flexible interface 130 may further include a locking assembly 150 that is structured to define a locked state in which the head 110 is retained at a fixed angle relative to the shaft 120. The fixed angle may be any angle in the full range of possible angles from no pivoting (i.e., alignment with the shaft 120) to maximum angular difference from the shaft 120. The locking assembly 150 may also have an unlocked state in which the head 110 is free to pivot relative to the shaft 120. As shown in FIG. 1, an actuator 152 may be provided to transition the locking assembly 150 between the locked and the unlocked state.

The unlocked state may, for many tools, be merely a transient state. In this regard, many tools may provide biasing to place the locking assembly (if included) in the locked state. Thus, for example, using the actuator 152 in connection with a conventional hand tool with a flexible head would typically keep the tool in the unlocked state only for as long as the operator manually holds the actuator 152 against the biasing provided. However, the hand tool 100 of an example embodiment may include a retention assembly 160 that is configured to enable the locking assembly 150 (and/or the actuator 152) to be retained in each of the locked state and the unlocked state.

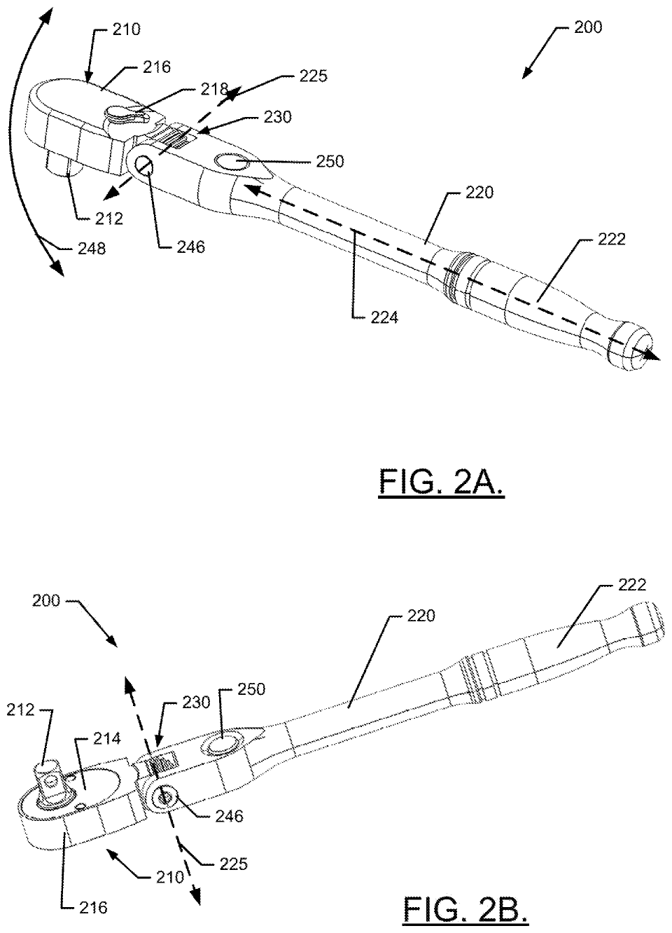

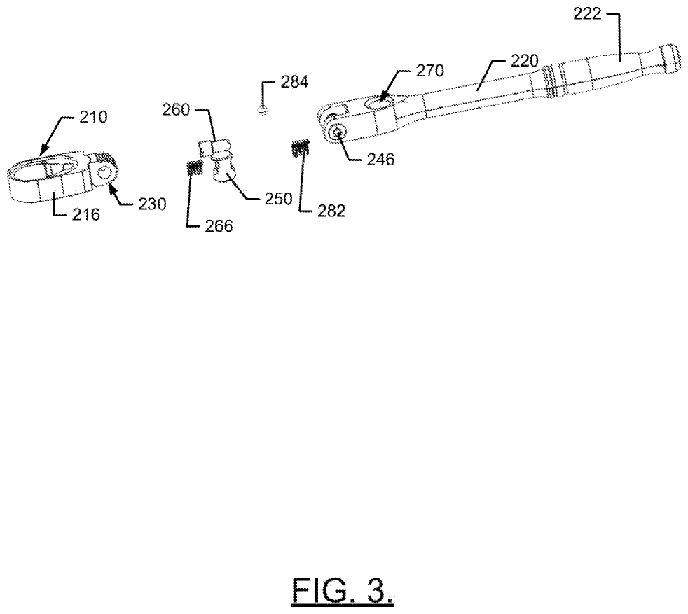

As can be appreciated from the descriptions above, the flexible interface 130 may take a number of forms from a structural perspective. Thus, the locking assembly 150, the actuator 152 and the retention assembly 160 may also take a number of different forms. FIGS. 2-6 illustrate various views of one example structure that may be used to embody the flexible interface 150 of one example embodiment.

FIG. 2, which is defined by FIGS. 2A and 2B, illustrates different perspective views (i.e., back and front views, respectively) of a hand tool 200, which operates as one example of the hand tool 100 of FIG. 1. FIG. 3 illustrates an exploded view of some components of the hand tool 200. As shown in FIGS. 2 and 3, the hand tool 200 may include a head portion 210 (e.g., a ratchet head), which includes a driving member 212 (e.g., a drive square), a ratchet assembly 214 housed in a body 216 of the head portion 210, and a direction selector 218. The direction selector 218 may be used to select which direction torque can be applied versus which direction torque is not applied when ratcheting is enabled via the ratchet assembly 214. The driving member 212 may interface with a selected socket that actually interfaces with the fastener that is being turned or gripped. Various internal components of the head portion 210, and specifically the ratchet assembly 214, may control the ratcheting capability, and are outside the scope of this disclosure. However, it should also be appreciated that example embodiments could be practiced in a context in which ratcheting is or is not included. In other words, the head portion 210 could be replaced with either an open-end wrench head or a box-end wrench head (with or without ratchet capabilities).

The head portion 210 may be operably coupled to a first end (e.g., a proximal end) of a shaft 220. A handle portion 222 (or grip portion) may be disposed proximate to a second end (e.g., a distal end) of the shaft 220. A longitudinal centerline 224 or axis of the shaft 220 may also form a longitudinal centerline or axis of the hand tool 200. The shaft 220, the head portion 210, and various other portions of the hand tool 200 may be made of steel or another extremely strong material. The handle portion 222 may be made of steel as well, and have a knurled outer periphery that enhances the ability of the operator to grip the shaft 220 effectively. However, the handle portion 222 could alternatively be made of a different material that is slid over the shaft 220 in some cases.

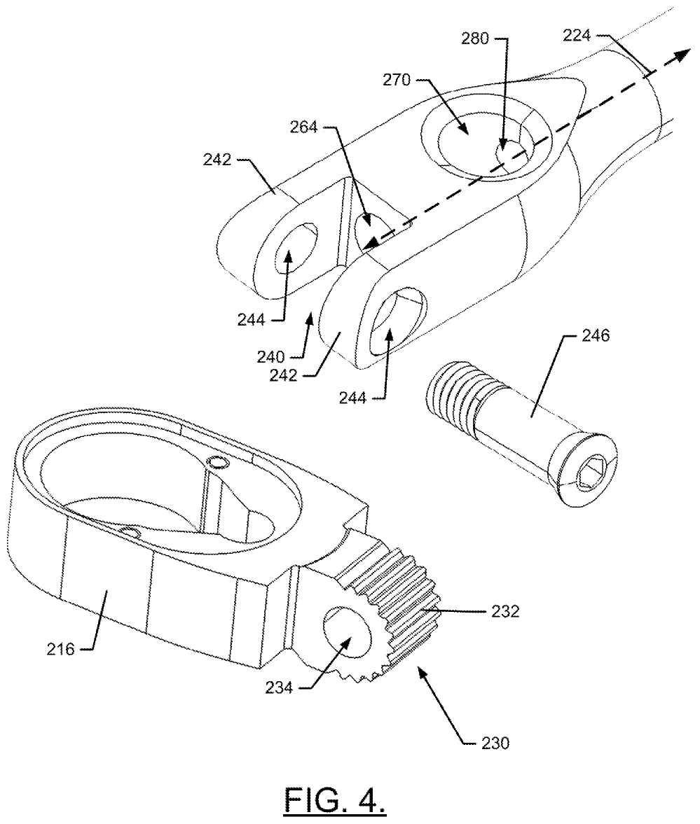

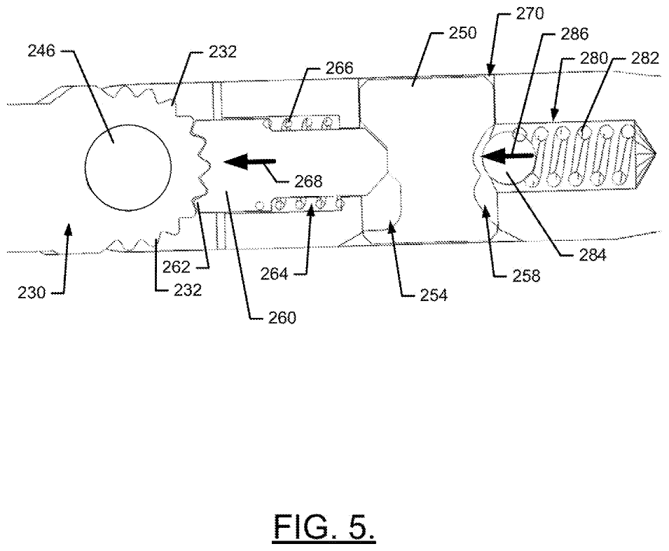

The first end of the shaft 220 may be operably (and pivotally) attached to the head portion 210 via structures that form an example of the flexible interface 130 of FIG. 1. In this regard, some portions of the flexible interface 130 are shown in greater detail in FIGS. 4 and 5 (which is a cross section view). As shown in FIGS. 2-5, the body 216 of the head portion 210 may include a neck 230 having a proximal end (relative to the shaft 220) that is rounded and includes a plurality of teeth 232 (or other projections or ridges) around a periphery of the rounded portion of the proximal end of the neck 230. A pivot channel 234 may be formed in the neck 230, and may extend substantially perpendicular to the longitudinal centerline 224 of the shaft 220. The rounded portion (and therefore the teeth 232) on the neck 230 may be substantially equidistant from a center (or pivot axis 225) of the pivot channel 234.

Meanwhile, the first end of the shaft 220 may include a receiving slot 240 formed between two shoulder members 242 that extend substantially parallel to the direction of extension of the longitudinal centerline 224 on opposite sides of the receiving slot 240. The shoulder members 242 may each include a pivot orifice 244 formed therein, and the pivot orifices 244 of each shoulder member 242 may align with each other and extend substantially perpendicular to the direction of extension of the longitudinal centerline 224. A diameter of the pivot orifices 244 may be substantially equal to a diameter of the pivot channel 234. The neck 230 may be inserted into the receiving slot 240, between the shoulder members 242, and the pivot orifices 244 may be aligned with the pivot channel 234. A pivot pin 246 may then be passed through each of the pivot orifices 244 and the pivot channel 234. A longitudinal center of the pivot pin 246 defines the pivot axis 225 about which the head portion 210 pivots relative to the shaft 220.

The pivot pin 246 may have a diameter slightly smaller than the diameters of the pivot orifices 244 and the pivot channel 234 to permit the head portion 210 to pivot freely about the pivot pin 246 (and therefore also the pivot axis 225). Although other fixing methods may be employed, in one example embodiment, the pivot pin 246 may have a threaded connection to just one of the pivot orifices 244. As noted above, the longitudinal centerline of the pivot pin 246 may form the pivot axis 225 about which the head portion 210 is then allowed to pivot relative to the shaft 220. As shown in FIG. 2, the head portion 210 may pivot out of alignment with the longitudinal centerline 224 of the shaft either upwardly or downwardly about the pivot pin 246 in directions shown by arrow 248.

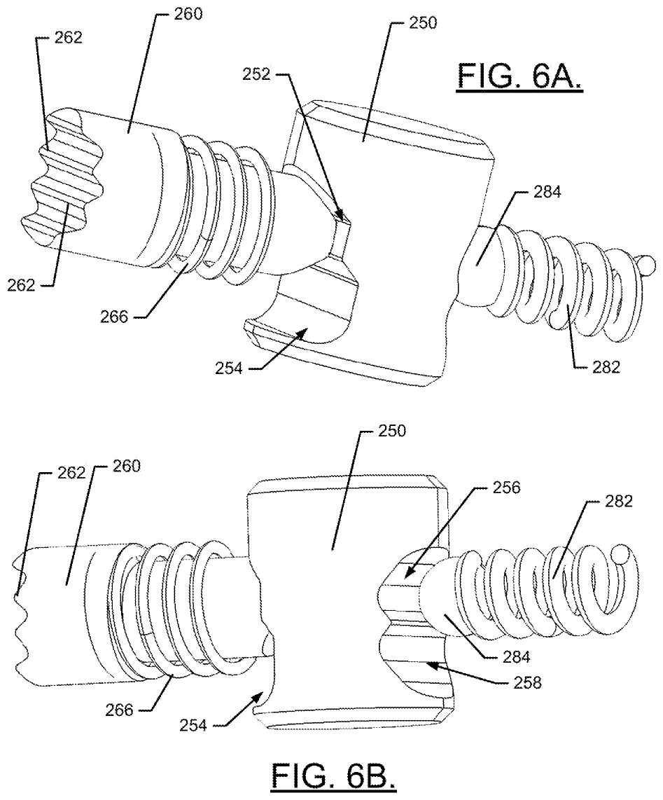

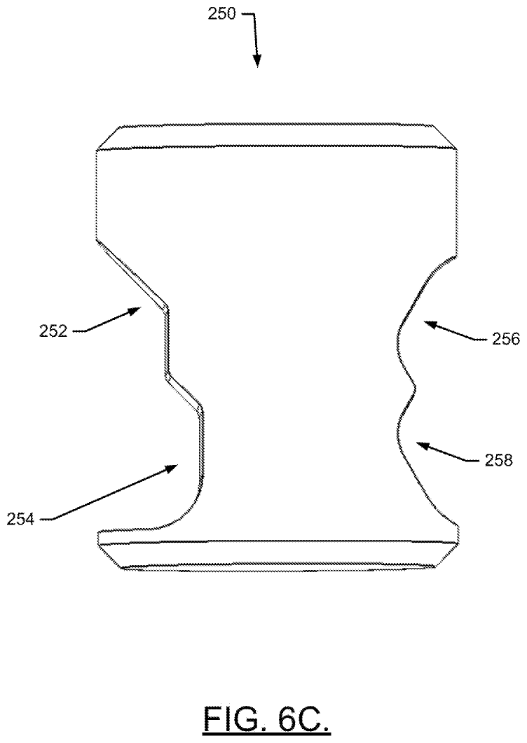

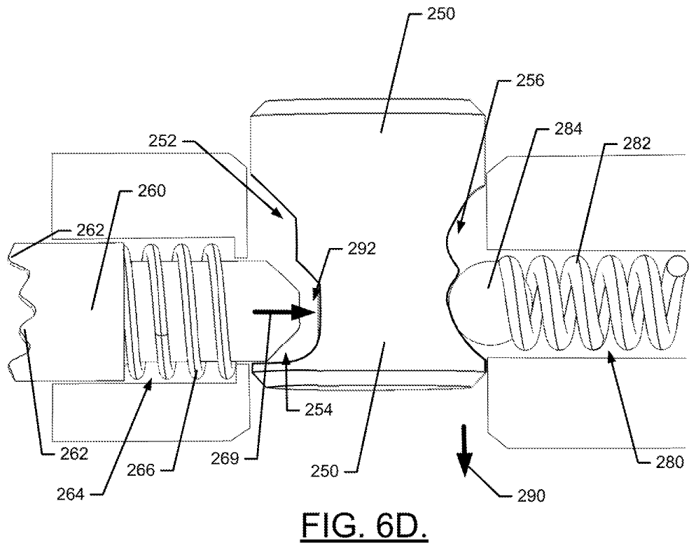

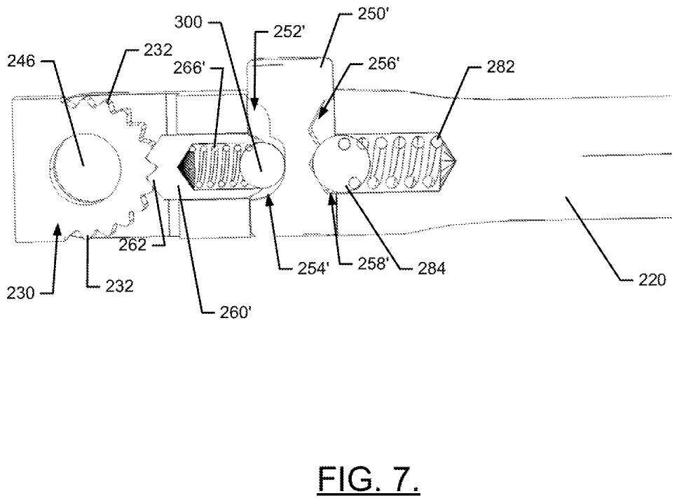

Thus, in general terms, the neck 230, the shoulder members 242 and the pivot pin 246 may form portions of the flexible interface 130 shown in FIG. 1. However, as noted above, example embodiments may further provide the flexible interface 130 of FIG. 1 with the capability to alternately unlock and lock the head portion 210 in relation to the shaft 220. The exploded view of FIG. 3, the cross section view of FIG. 5, and the various isolated component views of FIG. 6 illustrate components that may form the locking assembly 150 and retention assembly 160 of FIG. 1.

An actuator 250 (or button), shown in FIGS. 2-6 is one example of the actuator 152 of FIG. 1. The actuator 250 may be a substantially cylindrical body, except that a plurality of cavities may be formed in the opposing lateral sides of the actuator 250. The cavities may be used to facilitate transitions between the locked and unlocked states, as well as retention of the actuator 250 in each respective state (i.e., locked and unlocked). In this regard, the actuator 250 may include a locking cavity 252, and unlock cavity 254, a first retention cavity 256 and a second retention cavity 258.

In an example embodiment, the first and second retention cavities 256 and 258 may positioned adjacent to each other, and may be similar in shape and depth (measured inwardly from a lateral side of the actuator 250). However, whereas the first retention cavity 256 may be disposed at about a midpoint of the longitudinal length of the actuator 250, the second retention cavity 258 may be closer to one of the longitudinal ends of the actuator 250. In this regard, the second retention cavity 258 may be disposed between the first retention cavity 256 and the corresponding longitudinal end to which the second retention cavity 258 is closest.

The locking cavity 252 may be disposed on an opposing lateral side of the actuator 250 relative to the first retention cavity 256. Thus, the locking cavity 252 may also be disposed at about a midpoint of the longitudinal length of the actuator 250. Meanwhile, the unlock cavity 254 may be disposed on the opposing lateral side of the actuator 250 as well, and may be directly opposite the second retention cavity 258. However, the unlock cavity 254 may extend more deeply into the lateral side of the actuator 250 than the locking cavity 252.

The actuator 250 may interface with a locking pin 260 that includes one or more engagement projections 262 that selectively engage the teeth 232 of the rounded portion of the neck 230 to transition the hand tool 200 between the locked state and the unlocked state. In an example embodiment, the locking pin 260 may be disposed in a locking pin channel 264 formed in the shaft 220, and extending from the receiving slot 240 rearward along the longitudinal centerline 224 toward an actuator cavity 270 inside which the actuator 250 is movable (between locked and unlocked positions). The locking pin 260 may be biased toward engagement with the neck 230 by a first biasing member (e.g., locking spring 266). In this regard, the engagement projections 262 may be urged into contact with the teeth 232 by the force exerted by the locking spring 266 in a direction toward the neck 230 as shown by 5 arrow 268 in FIG. 5. As such, the locking pin 260 may move within the locking pin channel 264 in the direction of arrow 268 responsive to force from the locking spring 266, and in a direction opposite that of arrow 268 when forces overcoming the biasing force of the locking spring 266 push the locking pin 260 in the other direction.

The actuator cavity 270 may extend substantially perpendicular to the longitudinal centerline 224 (and the locking pin channel 264) and pass entirely through a portion of the first end of the shaft 220 that is spaced apart from the receiving slot 240 by the length of the locking pin channel 264. A diameter of the actuator cavity 270 may be slightly larger than a maximum diameter of the actuator 250 (i.e., the diameter without removal of material corresponding to the cavities described above). The actuator 250 may be moved up and down in the actuator cavity 270 to transition the actuator 250 between a locked position shown in FIGS. 2, 5, 6A and 6B and an unlocked position shown in FIG. 6D.

The locking pin channel 264 may intersect the actuator cavity 270 (and extend perpendicular thereto along the longitudinal centerline 224) on a first side of the first end of the shaft 220, and a retaining spring cavity 280 may intersect the actuator cavity 264 directly opposite the locking pin channel 264. Thus, the retaining spring cavity 280 may also extend along the longitudinal centerline 224 of the shaft 220, and may form a depression or hollowed out portion in the shaft 220. A second biasing member (e.g., retaining spring 282) may be disposed in the retaining spring cavity 280, and may urge a retaining ball 284 toward the actuator 250 (e.g., in a direction shown by arrow 286). However, in an alternative embodiment, the second biasing member may be entirely optional. In an alternative in which there is no retaining spring 282 and retaining ball 284, the first and second retention cavities 256 and 258 may also be removed.

The retaining ball 284 may be urged into either the first retention cavity 256 or the second retention cavity 258 depending on the position of the actuator 250. In this regard, when the actuator 250 is in the unlocked position of FIG. 6D, one longitudinal end of the actuator 250 may be pushed inside the actuator cavity 270 (in this case the lower or bottom end) and the other longitudinal end (i.e., the upper or top end in this example) may extend out of the actuator cavity 270. The lower or bottom end of the actuator 250 is therefore closer to the longitudinal centerline 224 than the upper or top end of the actuator 250. Meanwhile, the retaining ball 284 may be urged into the second retention cavity 258.

When the actuator 250 is in the locked position of FIGS. 2, 5, 6A and 6B, the longitudinal ends of the actuator 250 are substantially equidistant from the longitudinal centerline 224. The retaining ball 284 is also aligned instead with the first retention cavity 5 256 and may be urged into the first retention cavity 256. Thus, it can be appreciated that when the pressure exerted on the upper or top end of the actuator 250 by the operator (in the direction of arrow 290) is sufficient to overcome the spring force exerted by the retaining spring 282, the retaining ball 284 moves slightly in a direction opposite the direction of arrow 286 to enable the retaining ball 284 to move from being seated within the second retention cavity 258 (as shown in FIG. 6D) to being seated within the first retention cavity 256. Similarly, when the pressure exerted on the lower or bottom end of the actuator 250 by the operator (in a direction opposite the direction of arrow 290) is sufficient to overcome the spring force exerted by the retaining spring 282, the retaining ball 284 moves slightly in a direction opposite the direction of arrow 286 to enable the retaining ball 284 to move from being seated within the first retention cavity 256 (as shown in FIGS. 6A and 6B) to being seated within the second retention cavity 258 (as shown in FIG. 6D).

As can be appreciated from the descriptions above, the retaining ball 284 retains the actuator 250 in each respective one of the locked position (which corresponds to the locked state), and the unlocked position (which corresponds to the unlocked state). Thus, it can be appreciated that the first and second retention cavities 256 and 258, the retaining ball 284 and the retaining spring 286 may form portions of the retention assembly 160 of FIG. 1. The retention assembly 160 operates to ensure that the flexible interface 130 is retained in its current state as defined by the locking assembly 150 (e.g., either the locked state or the unlocked state). As such, neither the locked state nor the unlocked state is merely a transient state. Moreover, neither the locked state nor the unlocked state requires operator intervention to retain the hand tool 200 in the corresponding state. Instead, there are two stable states (locked and unlocked) that can be achieved and retained by the hand tool 200. However, the two stable states are relatively easy and uncomplicated to transition between.

When the actuator 250 is in the unlocked position (shown in FIG. 6D), the hand tool is in the unlocked state. In the unlocked state, the locking pin 260 is urged toward the neck 230 of the head portion 210 (as shown by arrow 268 in FIG. 5). However, the locking pin 260 is also aligned with the unlock cavity 254 leaving a gap 292 between the locking pin 260 and the actuator 250. This gap 292 permits movement of the locking pin 260 in the direction of arrow 269 (see FIG. 6D) when the operator exerts a rotational force on the head portion 210 to pivot the head portion 210 about the pivot pin 246. The rotational force, when sufficient to overcome the biasing force of locking spring 266, the teeth 232 push against the engagement protrusions 262 of the locking pin 260 and urge the locking pin 260 in the direction of arrow 269 (repeatedly if force is continuously applied) and into the unlock cavity 254. Thus, the unlock cavity 254 provides a space into which the locking pin 260 can be moved when pressure or force is applied by the operator to pivot the head portion 210 while the hand tool 200 is in the unlocked state. In some cases, the rotation of the neck 230 (to corresponding different angles) and repeated displacement of the locking pin 260 to overcome each engagement between teeth 232 and corresponding engagement protrusions 262 may act like a ratchet and make repeated clicking noises to alert the operator of the changing positions of alignment that are being made with each click. However, no such movement may be possible in the locked state.

When the actuator 250 is in the locked position (as shown in FIGS. 2, 5, 6A and 6B), the hand tool 200 is in the locked state. In the locked state (i.e., while the actuator 250 is in the locked position), the distal end of the locking pin 260 (relative to the neck 230) engages with the walls of the locking cavity 252 and the proximal end of the locking pin 260 is engaged with the neck 230. In particular, the engagement projections 262 of the locking pin 260 are engaged with the teeth 232 of the neck 230 to prevent any pivoting of the head portion 210 relative to the shaft 220. Thus, whatever angle the head portion 210 may have been turned to in the unlocked state (as described above), the movement of the actuator 250 to the locked position causes the actuator 250 to bind the locking pin 260 in between the walls of the locking cavity 252 and the neck 230 (thereby preventing rotation or pivoting of the head portion 210). In other words, the locking cavity 252 does not provide the space to permit movement of the locking pin 260 to change the angle of the head portion 210, as is provided by the unlock cavity 254.

As noted above, the structures shown in FIGS. 2-6 are merely examples of one way to embody the functions described in reference to FIG. 1. FIG. 7 illustrates slightly different structures that could be used to achieve the same purposes. In this regard, FIG. 7 is a cross section view of a hand tool similar to that of FIGS. 2-6, but using slightly different structures to embody the retention assembly and/or locking assembly. Specifically, actuator 250′ is longer than the actuator 250 of FIGS. 2-6. Thus, the first and second retention cavities 256′ and 258′ of FIG. 7 mirror each other about a longitudinal midpoint of the actuator 250′. Another change is that locking spring 266′ is housed inside of locking pin 260′ and urges a locking ball 300 into either locking cavity 252′ or unlock cavity 254′. Other structures are substantially similar to those of FIGS. 2-6.

As can be appreciated from the example of FIGS. 1-7, example embodiments may define a hand tool (i.e., a wrench or ratchet) with various unique features. The hand tool may include a head portion configured to interface with a fastener, a shaft having a longitudinal 5 centerline and a grip portion at which an operator is enabled to hold the hand tool during operation, and a flexible interface configured to operably couple the shaft and the head portion in a locked state and an unlocked state. The flexible interface may also be configured to enable the head portion to pivot relative to the shaft about a pivot axis that extends substantially perpendicular to a direction of extension (e.g., the longitudinal centerline) of the shaft. In the unlocked state, an angle of the head portion may be pivotable relative to the pivot axis. In the locked state, the angle of the head portion may be fixed. The flexible interface may include a locking assembly including an actuator having a locked position defining the locked state and an unlocked position defining the unlocked state. The flexible interface may also include a retention assembly configured to retain the actuator in each respective one of the locked position and the unlocked position.

The hand tool and/or its components may include a number of modifications, augmentations, or optional additions, some of which are described herein. These modifications, augmentations or optional additions may be included in any combination. For example, the actuator may include a push button that is disposed in an actuator cavity that extends through a proximal end of the shaft relative to the head portion substantially perpendicular to the pivot axis. In an example embodiment, the retention assembly may include a first retention cavity disposed at a middle portion of a first side of the actuator, and a second retention cavity disposed adjacent to the first retention cavity between the first retention cavity and a longitudinal end of the actuator on the first side of the actuator. In some cases, the retention assembly may further include a retention spring and a retention ball, and the retention spring may urge the retention ball into the first retention cavity in the locked position and into the second retention cavity in the unlocked position. In an example embodiment, the locking assembly may include a locking pin disposed in a locking pin channel extending along the longitudinal centerline or substantially perpendicular to the pivot axis to intersect the actuator cavity, and the actuator may include a locking cavity disposed opposite the first retention cavity and an unlock cavity disposed opposite the second retention cavity. In some cases, the unlock cavity may extend deeper into a lateral side of the actuator than the locking cavity. In an example embodiment, the head portion may include a neck configured to extend into a reception slot formed at the proximal end of the shaft. The neck may have a rounded periphery with a plurality of teeth, and the locking pin may include one or more engagement protrusions configured to engage the teeth of the neck. In some cases, the locking pin may be biased via a locking spring to urge the locking pin into contact with the neck. When the actuator is in the locked position, the locking pin may inserted into the locking cavity to prevent movement of the locking pin out of engagement with the neck. When the actuator is in the unlocked position, the locking pin may be aligned with the unlock cavity to enable a force exerted to pivot the head portion to overcome biasing of the locking spring to move the locking pin into the unlock cavity to enable the head portion to pivot relative to the shaft. In an example embodiment, the locking assembly may be configured to interface with a first side of the actuator to define the locked state and the unlocked state. The retention assembly may be configured to interface with a second side of the actuator opposite the first side to retain the actuator in the each respective one of the locked position and the unlocked position. In some cases, the locking assembly and retention assembly may be configured such that both the locking assembly and the retention assembly simultaneously engage opposite sides of the actuator in the locked state, but only the retention assembly engages the actuator in the unlocked state.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A hand tool comprising:
a head portion configured to interface with a fastener;
a shaft having a grip portion at which an operator is enabled to hold the hand tool during operation; and
a flexible interface configured to operably couple the shaft and the head portion in a locked state and an unlocked state, and to enable the head portion to pivot relative to the shaft about a pivot axis that extends substantially perpendicular to a direction of extension of the shaft,
wherein, in the unlocked state, an angle of the head portion is pivotable relative to the pivot axis and, in the locked state, the angle of the head portion is fixed,
wherein the flexible interface comprises a locking assembly including an actuator having a locked position defining the locked state and an unlocked position defining the unlocked state, and
wherein the flexible interface further comprises a retention assembly configured to retain the actuator in each respective one of the locked position and the unlocked position.

2. The hand tool of claim 1, wherein the actuator comprises a push button that is disposed in an actuator cavity that extends through a proximal end of the shaft relative to the head portion substantially perpendicular to the pivot axis.

3. The hand tool of claim 2, wherein the retention assembly comprises a first retention cavity disposed at a middle portion of a first side of the actuator, and a second retention cavity disposed adjacent to the first retention cavity between the first retention cavity and a longitudinal end of the actuator on the first side of the actuator.

4. The hand tool of claim 3, wherein the retention assembly further comprises a retention spring and a retention ball, and
wherein the retention spring urges the retention ball into the first retention cavity in the locked position and into the second retention cavity in the unlocked position.

5. The hand tool of claim 4, wherein the locking assembly comprises a locking pin disposed in a locking pin channel extending substantially perpendicular to the pivot axis to intersect the actuator cavity, and
wherein the actuator comprises a locking cavity disposed opposite the first retention cavity and an unlock cavity disposed opposite the second retention cavity.

6. The hand tool of claim 5, wherein the unlock cavity extends deeper into a lateral side of the actuator than the locking cavity.

7. The hand tool of claim 6, wherein the head portion comprises a neck configured to extend into a reception slot formed at the proximal end of the shaft, the neck having a rounded periphery with a plurality of teeth, and
wherein the locking pin comprises one or more engagement protrusions configured to engage the teeth of the neck.

8. The hand tool of claim 7, wherein the locking pin is biased via a locking spring to urge the locking pin into contact with the neck, and
wherein, when the actuator is in the locked position, the locking pin is inserted into the locking cavity to prevent movement of the locking pin out of engagement with the neck, and
wherein, when the actuator is in the unlocked position, the locking pin is aligned with the unlock cavity to enable a force exerted to pivot the head portion to overcome biasing of the locking spring to move the locking pin into the unlock cavity to enable the head portion to pivot relative to the shaft.

9. The hand tool of claim 1, wherein the locking assembly is configured to interface with a first side of the actuator to define the locked state and the unlocked state, and
wherein the retention assembly is configured to interface with a second side of the actuator opposite the first side to retain the actuator in the each respective one of the locked position and the unlocked position.

10. The hand tool of claim 1, wherein the locking assembly and retention assembly are configured such that both the locking assembly and the retention assembly simultaneously engage opposite sides of the actuator in the locked state, but only the retention assembly engages the actuator in the unlocked state.

11. A flexible interface operably coupling a head portion and a shaft of a hand tool to enable the head portion to pivot relative to the shaft about a pivot axis that extends substantially perpendicular to a direction of extension of the shaft, the flexible interface comprising:
a locking assembly including an actuator having a locked position defining a locked state for the hand tool and an unlocked position defining an unlocked state for the hand tool; and
a retention assembly,
wherein, in the unlocked state, an angle of the head portion is pivotable relative to a pivot axis and, in the locked state, the angle of the head portion is fixed, and
wherein the retention assembly is configured to retain the actuator in each respective one of the locked position and the unlocked position.

12. The flexible interface of claim 11, wherein the actuator comprises a push button that is disposed in an actuator cavity that extends through a proximal end of the shaft relative to the head portion substantially perpendicular to the pivot axis.

13. The flexible interface of claim 12, wherein the retention assembly comprises a first retention cavity disposed at a middle portion of a first side of the actuator, and a second retention cavity disposed adjacent to the first retention cavity between the first retention cavity and a longitudinal end of the actuator on the first side of the actuator.

14. The flexible interface of claim 13, wherein the retention assembly further comprises a retention spring and a retention ball, and
wherein the retention spring urges the retention ball into the first retention cavity in the locked position and into the second retention cavity in the unlocked position.

15. The flexible interface of claim 14, wherein the locking assembly comprises a locking pin disposed in a locking pin channel extending substantially perpendicular to the pivot axis to intersect the actuator cavity, and
wherein the actuator comprises a locking cavity disposed opposite the first retention cavity and an unlock cavity disposed opposite the second retention cavity.

16. The flexible interface of claim 15, wherein the unlock cavity extends deeper into a lateral side of the actuator than the locking cavity.

17. The flexible interface of claim 16, wherein the head portion comprises a neck configured to extend into a reception slot formed at the proximal end of the shaft, the neck having a rounded periphery with a plurality of teeth, and
wherein the locking pin comprises one or more engagement protrusions configured to engage the teeth of the neck.

18. The flexible interface of claim 17, wherein the locking pin is biased via a locking spring to urge the locking pin into contact with the neck, and
wherein, when the actuator is in the locked position, the locking pin is inserted into the locking cavity to prevent movement of the locking pin out of engagement with the neck, and
wherein, when the actuator is in the unlocked position, the locking pin is aligned with the unlock cavity to enable a force exerted to pivot the head portion to overcome biasing of the locking spring to move the locking pin into the unlock cavity to enable the head portion to pivot relative to the shaft.

19. The flexible interface of claim 11, wherein the locking assembly is configured to interface with a first side of the actuator to define the locked state and the unlocked state, and
wherein the retention assembly is configured to interface with a second side of the actuator opposite the first side to retain the actuator in the each respective one of the locked position and the unlocked position.

20. The flexible interface of claim 11, wherein the locking assembly and retention assembly are configured such that both the locking assembly and the retention assembly simultaneously engage opposite sides of the actuator in the locked state, but only the retention assembly engages the actuator in the unlocked state.
